(19) United States
(12) Patent Application Publication
(10) Pub. No.: US 2010/0232743 A1
(43) Pub. Date: Sep. 16, 2010

(54) OPTICAL-PATH TURNING MEMBER AND OPTICAL-PATH TURNING OPTICAL CONNECTOR

(75) Inventors: Takaaki Ishikawa, Sakura-shi (JP); Akito Nishimura, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd, Koto-ku, Tokyo (JP)

(21) Appl. No.: 12/438,493

(22) PCT Filed: Jul. 31, 2007
(86) PCT No.: PCT/JP2007/064969

§ 371 Date: Feb. 23, 2009

(30) Foreign Application Priority Data
Aug. 24, 2006 (JP) 2006-227842

(51) Int. Cl. G02B 6/12; G02B 6/36

(52) U.S. Cl. 385/14; 385/88

(57) ABSTRACT

In a light path converting member (11), on an upper side surface of a base substrate (first substrate) (12) having a curved leading end surface (12b) smoothly continued from a flat upper surface (12a), a plurality of arranged positioning grooves (12c) and formed, and a cover member (second substrate) (14) having a surface (14a) along the upper side surface of the base substrate (12) is arranged for pressing an optical fiber stored in the positioning grooves (12c) on the base substrate (12). The optical path converting member (11) can be used, for instance, as a connector for light path converted light, for optically coupling an optical element on the optical circuit substrate with the optical fiber.

### TECHNICAL FIELD

The present invention relates to an optical-path turning member and an optical-path turning optical connector.

### BACKGROUND ART

Optical instruments need an optical path to be turned in a variety of cases. For instance, turning an optical path is necessary for an optical module to implement an optical connection between a surface-emitting element mounted on an optical circuit substrate and an optical fiber guided parallel to the optical circuit substrate. There is an optical-path turning means disclosed in patent document 1, where as illustrated in FIG. 1 a package 1 has therein a lens 3 disposed above an optical element 2, a 45°-inclined mirror 4 disposed thereabove, and an optical fiber 5 arranged parallel to the mirror 4, whereby an optical path is turned.

Further, turning an optical path is necessary also for an optical connector of which an end face for connection has a different orientation relative to an optical cord introducing direction. There is an optical-path turning means disclosed in patent document 2, where as illustrated in FIG. 2 a curvilinear tubular bent guide portion 7 that bas an optical cord holding hole 7a for an optical cord to be let into is integrally formed on an optical connector housing 8 that has an optical ferrule insertion hole 8a, whereby an optical path is turned. In this case, the bent guide portion 7 has a radius of curvature greater in curvature than a permissible bending radius of the optical cord.

Further, there is an optical-path turning means disclosed in patent document 3, where as illustrated in FIG. 3 an optical fiber guide 9 is employed, in which a receptacle portion 9c adapted to hold an optical connector is formed at a distal end part of a curved gutter-shaped elongate member 9b adapted for accommodation of an optical cord and framed with optical cord fixing lugs 9a, whereby an optical path is turned. In this case, the optical connector is detachably attachable to the receptacle portion 9c. Further, the optical fiber guide 9 has a radius of curvature greater in curvature than a permissible bending radius of the optical cord.

Patent document 1: Japanese Patent Application Laid-Open Publication No. 2006-065358
Patent document 2: Japanese Patent Application Laid-Open Publication No. 2003-161863
Patent document 3: Japanese Patent Application Laid-Open Publication No. 2002-357752

### DISCLOSURE OF INVENTION

### Problems to be Solved by the Invention

Such an optical path turning method that employs a lens 3 and a mirror 4, like the optical-path turning means in FIG. 1, has a complicate structure, needing many component parts, requiring them to be fabricated with high precision, with a resultant high cost.

Moreover, the lens 3 and the mirror 4 intervene between an optical element 2 and an end face of optical fiber 5, having optical losses caused at the lens 3 and the mirror 4.

Further, provision of a long spatial interval for optical path is necessary between the optical element 2 and the end face of optical fiber 5, having optical losses caused in the spatial interval for optical path.

Further, provision of an empty space is needed to turn an optical path including the lens 3 and the mirror 4, constituting a difficulty to implement a sufficient miniaturization.

Such optical-path turning means as in patent document 2 or patent document 3 are inadequate for applications to an optical-path taming system on an optical circuit substrate, for instance.

The present invention has been devised in view of the problems described, and it is its object to provide an optical-path turning member adapted for fabrication with an inexpensive cost, reduced optical loss, and facilitated miniaturization, such as for implementation of turning an optical path on an optical circuit substrate, for instance, as well as an optical-path turning optical connector employing the same.

### Means for Solving the Problems

To solve the problems, according to a first aspect of the present invention, an optical-path turning member comprises a first substrate comprising an upside having a flat upper surface and a curvilinear distal end surface smoothly connected to the flat upper surface, and positioning grooves set in array on the upside for optical fibers to be positioned therein, and a second substrate having a lower surface configured along the upside of the first substrate to hold down the optical fibers accommodated in positioning grooves.

According to a second aspect of the present invention, an optical-path turning member comprises an end plate having a two-dimensional array of optical fiber insertion holes, and a hollow guide configured to curvilinearly guide optical fibers respectively inserted in optical fiber insertion holes of the end plate in directions perpendicular to the and plate.

According to a third aspect of the present invention, an optical-path turning member comprises a pair of end plates having two-dimensional arrays of optical fiber insertion holes and arranged at an angle to each other, and a hollow guide configured to curvilinearly guide optical fibers respectively inserted in optical fiber insertion holes of the pair of end plates.

According to a fourth aspect of the present invention, an optical-path turning optical connector, which employs an optical-path turning member according to the first aspect, comprises the optical-path tuning member according to the first aspect having a positioning groove outlet portion at an end of the curvilinear distal end face as a connector connection, end face.

According to a fifth aspect of the present invention, an optical-path taming optical connector, which employs an optical-path turning member according to the second or third aspect, comprises the optical-path turning member according to the second or third aspect having a surface at an, optical fiber insertion hole outlet side of at least one end plate as a connector connection end face.

### BRIEF DESCRIPTION OF DRAWINGS

FIG. 1 illustrates an example in the past, as a sectional view of an optical module having an optical path turning portion.

FIG. 2 illustrates another example in the past, at FIG. 2(a) as a sectional view of an optical connector having an optical-path turning portion, and FIG. 2(b) as a right elevation of the same.

FIG. 3 illustrates still another example, as a perspective view of an optical-path turning optical fiber guide.

FIG. 4 illustrates a first embodiment of the present invention, as a perspective view of an optical-path turning member.

FIG. 5 is a sectional view of the optical-path turning member of FIG. 4, in a state of use.

FIG. 6 is a sectional view along line VI-VI of FIG. 5.

FIG. 7 is a sectional view of an embodiment example as the optical-path turning optical connector provided with positioning pin holes.

FIG. 8 is a sectional view of a second embodiment employing the optical-path turning member as a simple optical-fiber flexural-holding member.

FIG. 9 illustrates a third embodiment of the present invention, as a perspective view of an optical-path turning optical connector.

FIG. 10 is a perspective view in which a lid member in FIG. 9 is removed.

FIG. 11 is a sectional view in which the optical-path turning optical connector of FIG. 9 is mounted on an optical circuit substrate.

FIG. 12 is a bottom view of FIG. 11.

FIG. 13 is a sectional view along line XIII-XIII of FIG. 11.

FIG. 14 is a sectional view in which the optical-path turning optical connector according to the third embodiment of the present invention is mounted on an optical circuit substrate.

FIG. 15 is a sectional view of a fifth embodiment employing an optical-path turning member in FIG. 14 as a simple optical-fiber flexural holding member.

### BEST MODE FOR CARRYING OUT THE INVENTION

There will be described optical-path turning members and optical-path turning optical connectors as embodiments of the present invention, with reference to drawings.

### First Embodiment

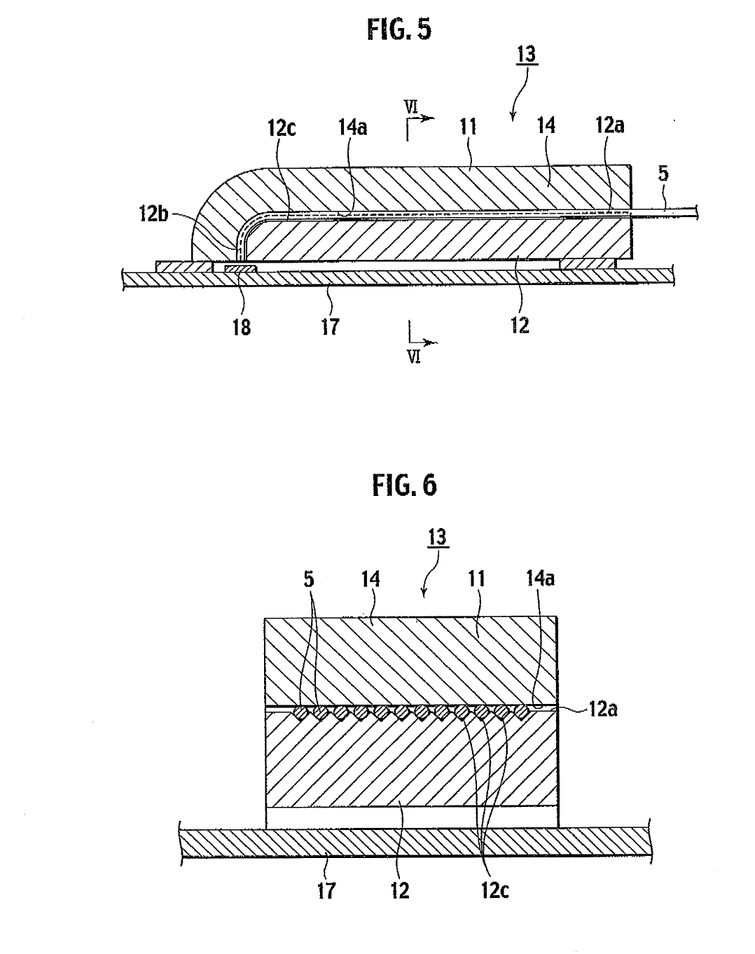

In FIG. 4 is illustrated an embodiment of an invention according to claim 1, as a perspective view of an optical-path turning member 11, FIG. 5 is a sectional view of the optical-path turning member 11 of FIG. 4, employed as an optical connector, and FIG. 6 is a sectional view along line VI-VI of FIG. 5. As illustrated in those figures, the optical-path turning member 11 is made up by a base substrate (as a first substrate) 12 that includes an upside having flat upper surfaces 12a and curvilinear distal end surfaces 12b smoothly connected to the flat upper surfaces 12a, and a plurality of positioning grooves 12c set in array on the upside for positioning optical fibers 5 therein, and a lid member (as a second substrate) 14 that has a lower surface 14a configured along the upside of the base substrate 12 to hold down those optical fibers 5 accommodated in positioning grooves 12c.

Positioning grooves 12c, a V-groove in this example, are not limited thereto, and may be a U-groove ox the like according to the invention.

The phrase “curvilinear distal end surfaces 12b smoothly connected to the flat upper surfaces 12a” refers herein to those upside regions that curvilinearly extend from the flat upper surfaces 12a toward a lower surface of the base substrate 12. Moreover; the phrase “set in array” refers to the plurality of positioning grooves 12c being formed mutually parallel and equally spaced. Further, the phrase “a lower surface 14a configured along the upside” refers to such a plane that has a fiat surface, and a curvilinear surface connected to the flat surface, like the above-noted upside, and is complementary in configuration to the upside of the base substrate 12.

The optical connector illustrated in FIG. 5 is configured as an optical-path turning optical connector 13 for optical coupling between optical fibers 5 extending parallel to an optical circuit substrate 17 and surface-emitting or surface-receiving optical elements 18 mounted on the optical circuit substrate 17. A procedure to assembly the optical-path turning optical connector 13 will be described.

First, on the base substrate 12, a respective positioning groove 12c has an optical fiber 5 accommodated therein. If the optical fiber 5 is a totally silica-based optical fiber, the coating may well be removed to have a bare optical fiber placed in the positioning groove 12c, thereby allowing for an enhanced positioning accuracy. Alternately, a coated optical fiber may be placed. If the optical fiber 5 is a POF (plastic optical fiber), it may well be placed as it is in the groove. Optical fibers 5 may have their end faces cut to trim in advance, or may have their ends trimmed after assembly, by a polishing, a laser cutting, or such.

Next, the lid member 14 is put on, fixing optical fibers 5 to positioning grooves 12c of the base substrate 12. For this, the lid member 14 may be set stationary to the base substrate 12 by means of an, adhesive, or may be mechanically fixed to the base substrate 12 by any fixing means or locking means.

The optical-path turning optical connector 13 is mounted on the optical circuit substrate 17, whereupon it is positioned so that optical fibers 5 have their ends facing optical elements 18, at the curvilinear distal end face 12b side.

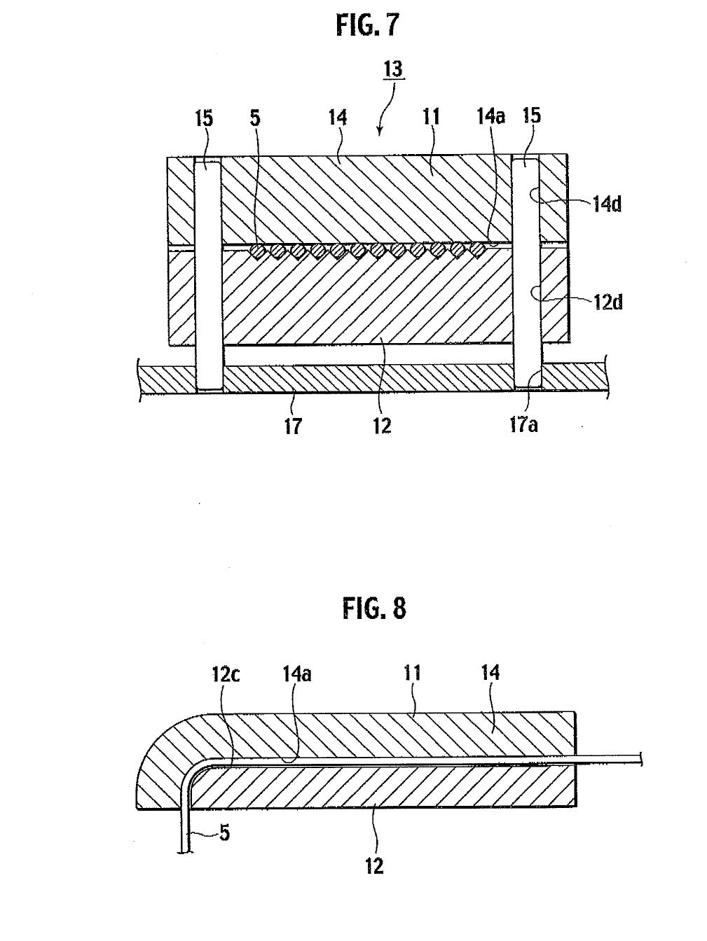

In addition, as illustrated in FIG. 7, an optical-path turning optical connector 13 to be positioned may have positioning pinholes 12d and 14d opened therethrough for insertion of insert pins 15 to a base substrate 12 as well as to a lid member 14. The insert pins 15 as inserted in the pinholes 12d and 14d may be inserted to positioning pinholes 17a opened at optical circuit substrate 17 ends, for a positioning for optical fibers 5 to be set to face optical elements 18.

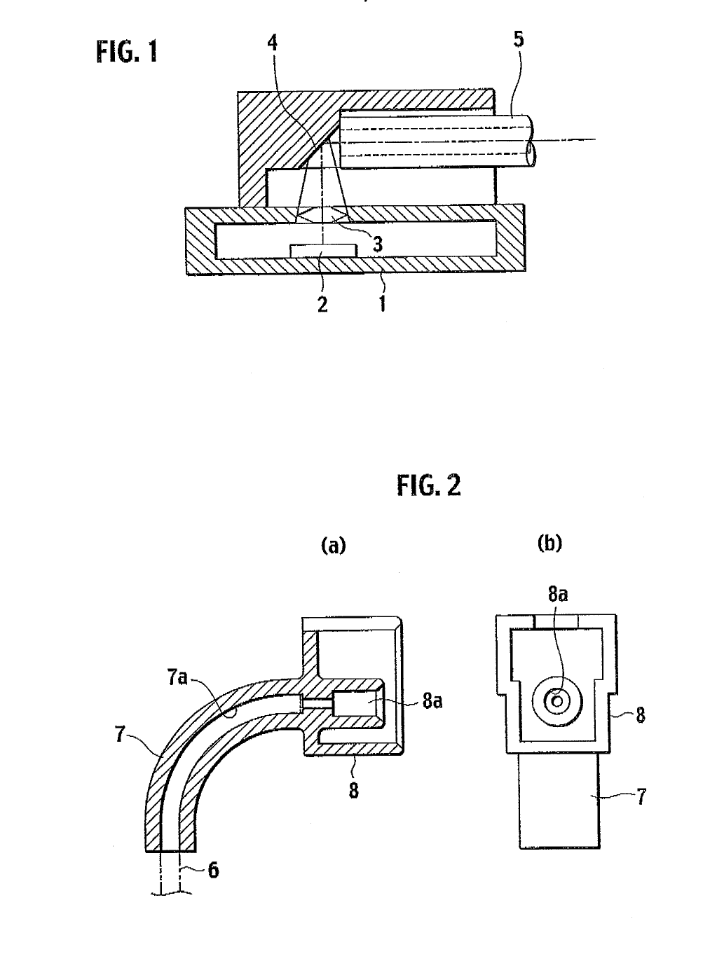

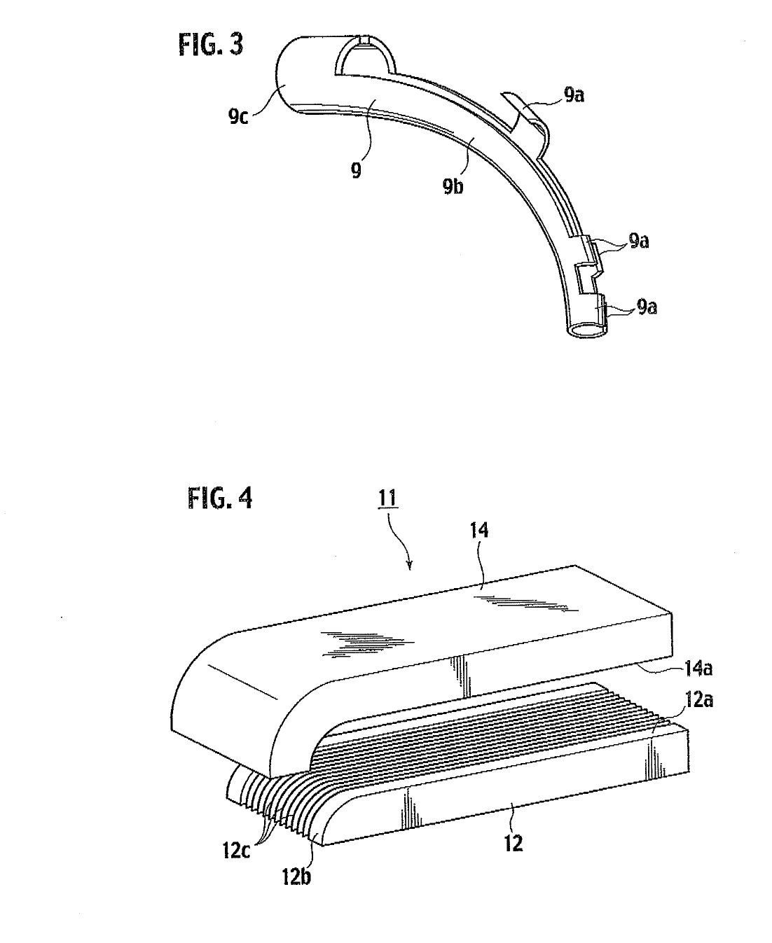

Accordingly, unlike the optical-path turning means in the past illustrated in FIG. 1, the optical-path turning optical connector 13 does not employ any lens or mirror, and has a simple structure free of difficulties to assemble them with high precision, thus allowing for an inexpensive fabrication.

Further, optical fibers 5 have their end faces directly facing optical elements 18 in vicinities thereof, thus allowing for reduced optical losses relative to a system in the past, where optical losses were caused by lens and mirror.

Further, there is little spatial interval left for any optical path between optical element 18 and end face of optical fiber 5, whereby also the optical loss is reduced relative to a system in the past that needed a long spatial interval for optical path.

Further, it is unnecessary to provide any empty space for turning an optical path including lens and minor, thus allowing for a facilitated implementation of miniaturization.

It is noted that as the optical fiber to be used has a smaller permissible bending radius, the base substrate 12 as well as the lid member 14 can be made thinner, allowing for provision of the more miniaturized optical-path turning optical connector. Using an optical fiber adaptive for small bending radii, such as a small-diameter optical fiber (e.g. 80 μm fiber), is advantageous to implement a miniaturization of optical-path turning optical connector, while typical optical fibers may well be used.

In other words, as an optical fiber now employable, it is allowed to use such an optical fiber that has less bending loss than a standard optical fiber, and can be left as it is with a reduced aging degradation, even in a bent state. Using such a low-bending-loss optical fiber enables implementation of an optical-path turning optical connector adapted for small bending radii and reduced in size. As used herein, the standard optical fiber refers to a kind of quartz glass optical fiber typically employed for a range of transmission wavelengths of 1,310 to 1,630 nm in optical fiber communications, for instance, and practically, covers those optical fibers having a minimum bending radius of 30 nm.

For instance, a core-assisted fiber or a photonic-crystal fiber is employable. The core-assisted fiber is an optical fiber that has air holes formed around a core to provide a light-confining structure. The photonic-crystal fiber is an optical fiber as a core-assisted fiber in which air holes are still, increased in number, so that air holes arranged in a perfect array like a crystal lattice constitute a photonic band gap, allowing for ingenious attempts such as in size, number, interval, or array of air holes to implement great reduction of bending loss.

Further, a polymer waveguide may also be employed as an optical fiber. For this a tape-form polymer waveguide may well be interposed between, a base substrate and a lid member.

Still more, as the low-bending-loss optical fiber to be used, there may be such a quartz glass optical fiber that has a smaller core diameter than a standard single-mode optical fiber, as typified by Future Guide SR15 (Fujikura trademark and model number), for instance. This optical fiber has a transmission wavelength of 1.55 μm, and can be curled ten turns to a diameter of 10 mm fiber, with a defined bending loss not exceeding 0.5 dB. To this point, the distribution of refraction index in section of optical fiber may be varied, to thereby provide an optical fiber with the less bending loss for use. As an example with a varied refraction index distribution, there is an optical fiber having a refraction index profile in a W form, trench form, etc.

Yet more, for use, there may well be a PCF (plastic clad optical fiber) having a plastic cover as a cladding around a quartz core.

The foregoing matters are common to the other embodiments of the present invention.

Further, for the optical-path turning member 11, the number of positioning grooves 12c or that of optical fibers 5 may be set arbitrarily, and one or more, in accordance with the present invention.

Further, although in this embodiment the positioning grooves 12c are disposed at the side of the base substrate 12, positioning grooves may be provided at the side of the lid member 14 in accordance with the present invention.

Further, that member (the base substrate 12 in this embodiment) to be provided with positioning grooves ling a cover member (the lid member 14 in this embodiment), which is not restricted to a rigid member. This may be any one that can hold down optical fibers accommodated in positioning grooves in accordance with the present invention.

Further, in this embodiment the optical-path turning member 11 is configured to change orientations of optical fibers at 90°, which however is not always limited to turning at 90°, in accordance with the present invention.

### Second Embodiment

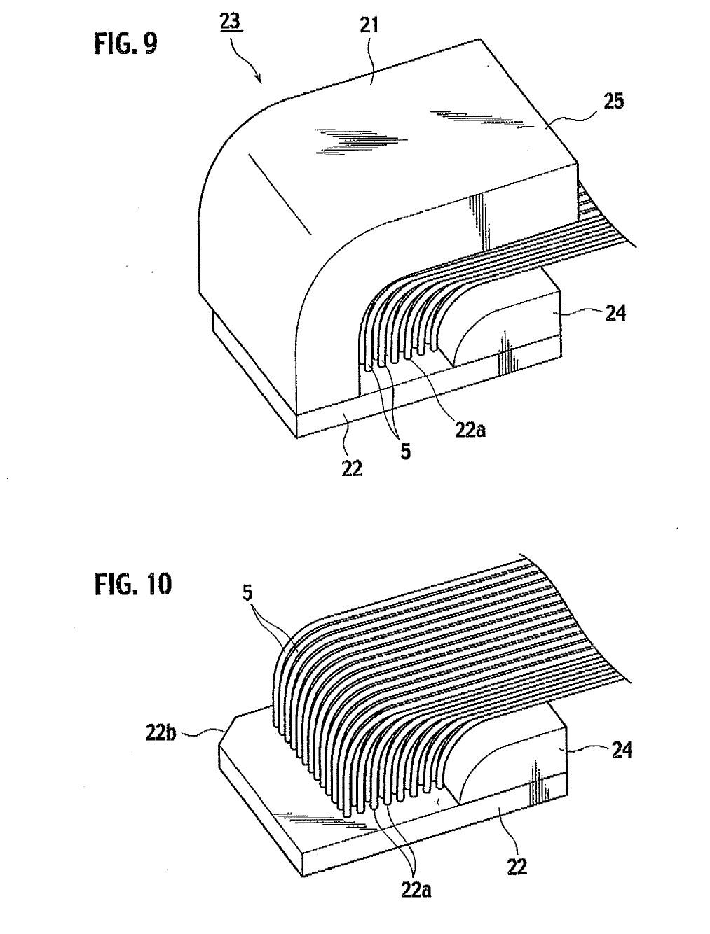

The optical-path turning member 11 in the first embodiment is applied to an optical-path turning optical connector, which may be modified, as illustrated in FIG. 8, to a simple optical-fiber flexural-holding member that is an optical-path turning member adapted to simply change orientations of optical fibers 5. In other words, those parts of the optical fibers 5 to be flexed are held between a base substrate 12 and a lid member 14, whereby orientations of optical fibers can be changed.

### Third Embodiment

FIGS. 9 to 13 illustrate an optical-path turning member 21 and an optical-path mining optical connector 23 according to the third embodiment of the present invention. The optical-path turning member 21 includes a fast end plate 22 that has a two-dimensional array of optical fiber insertion holes 22a, and a hollow guide portion 29 that is configured to curvilinearly guide optical fibers 5 respectively inserted in optical fiber insertion holes 22a of the end plate 22, so that their orientations are changed (at 90° in this embodiment) relative to directions perpendicular to the end plate 22.

As used herein, the two-dimensional array refers to an array of rows and columns of optical fiber insertion holes having equal pitches, for instance. It however is possible for array pitches to be identical simply within a column. And, for columns neighboring each other, array pitches between columns may be different from those within columns.

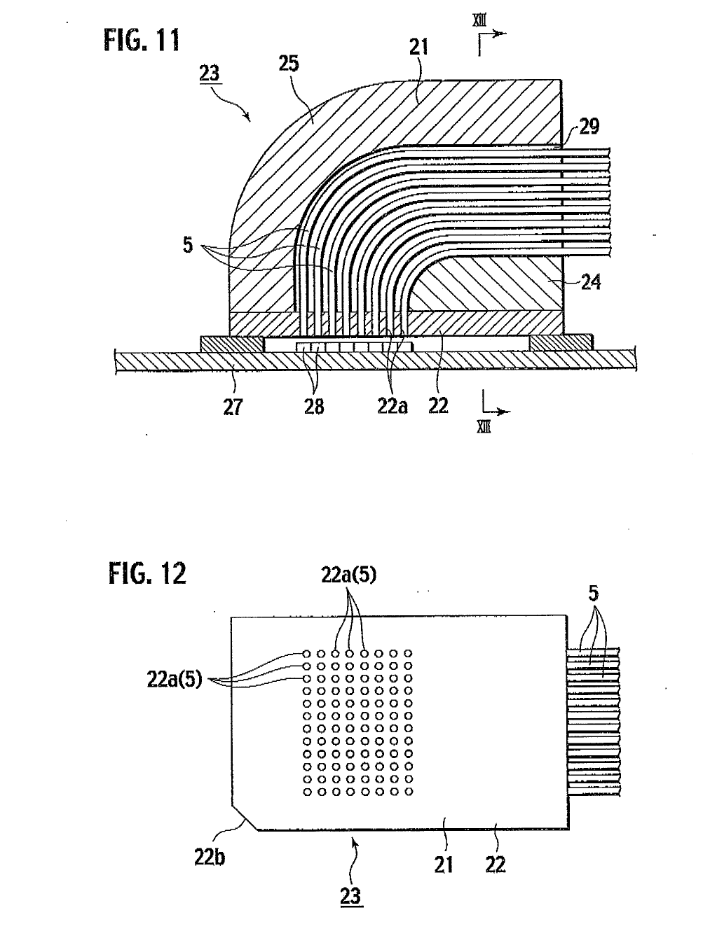

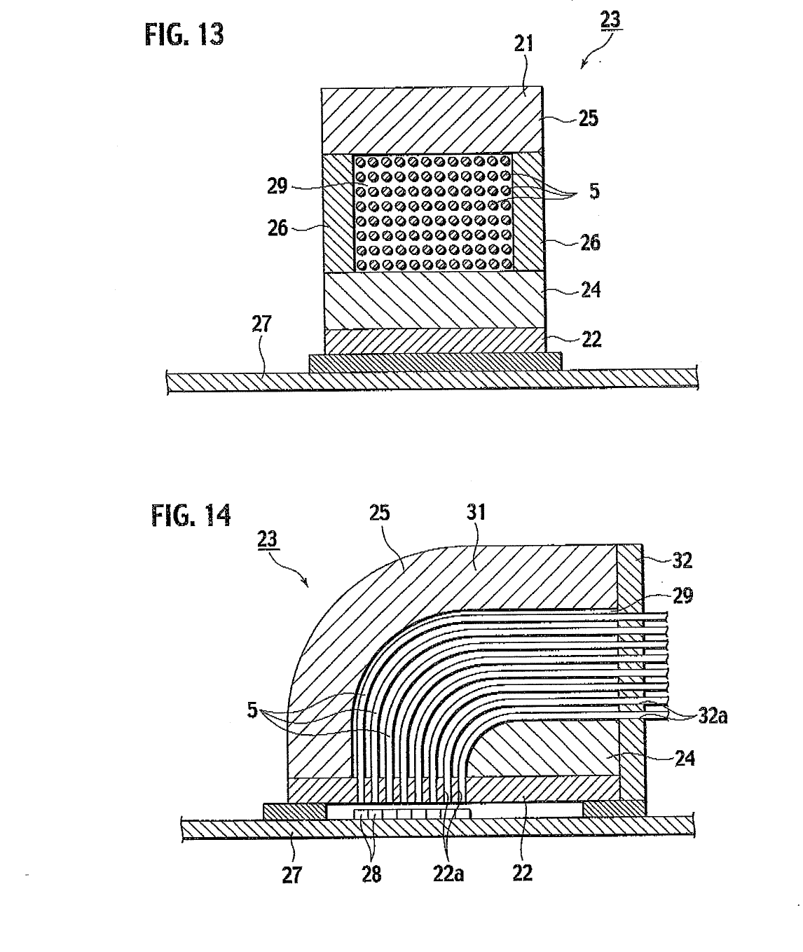

In this embodiment, the hollow guide portion 29 is made up by an inner guide member 24 that is pre-fixed on one side (right side in FIG. 11) of a region of optical fiber insertion holes 22a of the end plate 22, an outer guide member 25 that can be post-fixed on the other side (left side in FIG. 11) of the region of optical fiber insertion holes 22a of the end plate 22, and wall members 26 that can be post-fixed on transversely both sides (right and left sides in FIG. 13) of the region of optical fiber insertion holes 22a of the end plate 22.

The hollow guide portion 29 is not restricted to what is assembled by such the members 24, 25, and 26, and may be configured as an integral tubular member (curved pipe).

Description is now made of a procedure to assemble the optical-path turning optical connector 23 by using the optical-path turning member 21. First, optical fibers 5 are inserted at their ends in fix in optical fiber insertion holes 22a of the end plate 22. Optical fibers 5 may have their end faces cut to trim in advance, or may have their ends trimmed after assembly, by a polishing, a laser cutting, or such.

If any optical fiber 5 is a silica based optical fiber, a coating on its part to be inserted in an optical fiber insertion hole 22a may preferably be removed. Inserting a coating-removed bare optical fiber into a hole allows for an enhanced positioning accuracy. This is unnecessary for POF In other words, in an arraying configuration using an end plate of a two-dimensional array, quartz glass optical fibers stand as coated optical fibers, though not shown, else than those parts in the end plate.

Next, the outer guide member 25 is yet from above, having the optical fibers 5 arrayed in perpendicular directions along the hollow guide portion 29, as illustrated in FIG. 9 and FIG. 11. The outer guide member 25 may then be set stationary to the end plate 22 by means of an adhesive, or may be mechanically fixed to the end plate 22 by any fixing means or locking means. Next, right and left wall members 26 are fixed to the end plate 22 by an adhesive or mechanical means. It is noted that the right and left wall members 26 may be omitted.

In this embodiment, the hollow guide portion 29 provides a simple curved space, allowing optical, fibers to be curvilinearly guided without being individually bound, while there may well be some arraying means additionally provided for binding optical fibers 5 to their courses inside the hollow guide portion 29.

Next, the optical-path turning optical connector 23 as assembled is placed on an optical circuit substrate 27 with optical elements (surface-emitting or surface-receiving optical elements) 28 mounted thereon, whereupon it is positioned so that distal ends of optical fibers 5 (end face portion of end plate 22) face the optical elements 28.

For the optical-path turning optical connector 23 to be positioned, the optical-path turning member 21 may have positioning pinholes opened like FIG. 7, though not illustrated.

Accordingly, lake the first embodiment, the optical-path turning optical member 21 does not employ any lens or mirror, and has a simple structure free of difficulties to assemble them with high precision, thus allowing for an inexpensive fabrication.

Further, optical fibers 5 have their end faces directly facing optical elements 28 in vicinities thereof allowing for less optical losses.

Further, there is little spatial interval left for any optical path between optical element 28 and end face of optical fiber 5, whereby also the optical loss is reduced.

Further, it is unnecessary to provide any empty space for turning an optical path including lens and mirror, thus allowing for a facilitated implementation of miniaturization.

### Forth Embodiment

FIG. 14 illustrates another embodiment of the invention of claim 2. According to this embodiment, an optical-path turning member 31 and an optical-path turning optical connector 33 have similar fundamental structures to FIG. 9 to FIG. 13, while they are provided with a second end plate 32 perpendicular to an end plate 22 constituting an end face for connection to the optical-path turning optical connector 33. That is, the second end plate 32 is arranged to have right angles to an extending direction of the end plate 22 (as a face direction of the end plate 22 extending along the surface of an optical circuit substrate 27 in FIG. 14).

The second end plate 32 has a two-dimensional array of optical fiber insertion holes 32a, like the end plate 22 (as the first end plate). Provision of such the second end plate 32 facilitates arranging optical fibers 5 in array inside a hollow guide portion 29.

It is noted that, like the embodiments in FIG. 4 to FIG. 8, optical fibers to be used in the embodiments in FIG. 9 to FIG. 14 may also be, among others, a ma-diameter optical fiber (such as a 80μm fiber) or PCF fiber (as a photonic-crystal optical fiber), or may be a typical optical fiber.

Further, for the end plate 22, the number of optical fiber insertion holes 22a or that of optical fibers constitutes no object. In other words, in FIG. 11 and FIG. 12, this number is two or more in the horizontal direction, while in FIG. 12, it may be even a unity in the vertical direction.

Further, the end plate 22 may have a C-chamfer 22b for directional identification.

Further, the optical-path turning members 21 and 31, configured for a 90° turn of optical fibers in the embodiments, are not always restricted to the 90° turn.

### Fifth Embodiment

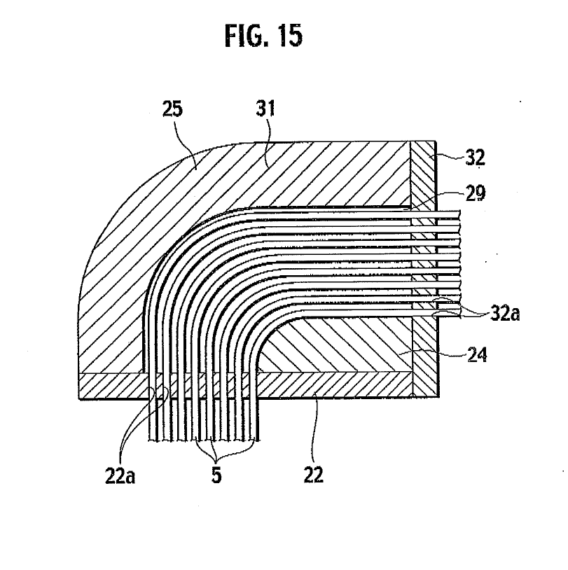

In the embodiment in FIG. 14, the optical-path turning member 31 is applied to an optical-path turning optical connector, which may be modified, as illustrated in FIG. 15, to a simple optical-fiber flexural-holding member that is an optical-path turning member adapted to simply change orientations of optical fibers 5. In other words, the optical fibers 5 are let through optical fiber insertion holes 22a and 32a of a first end plate 22 and a second end plate 32, whereby orientations of optical fibers 5 can be changed.

### INDUSTRIAL APPLICABILITY

Accordingly, the present invention does not employ any lens or mirror, and has a simple structure free of difficulties to assemble them with high precision, thus allowing for an inexpensive fabrication.

Further, optical fibers have their end faces directly facing optical elements in vicinities thereof thus allowing for less optical losses relative to a system in the past, where optical losses were caused by lens and mirror.

Further, there is little spatial interval left for any optical path between optical element and end face of optical fiber, whereby also the optical loss is reduced relative to a lens and mirror system that needs a long spatial interval for optical path.

Further, it is unnecessary to provide any empty space for turning an optical path including lens and mirror, thus allowing for a facilitated implementation of miniaturization.

1. An optical-path turning member comprising:
a first substrate comprising an upside having a fiat upper surface and a curvilinear distal end surface smoothly connected to the flat upper surface, and positioning grooves set in array on the upside for optical fibers to be positioned therein; and
a second substrate having a lower surface configured along the upside of the first substrate to hold down the optical fibers accommodated in positioning grooves.

2. An optical-path tuning member comprising:
an end plate having a two-dimensional array of optical fiber insertion holes; and
a hollow guide configured to curvilinearly guide optical fibers respectively inserted in optical fiber insertion holes of the end plate in directions perpendicular to the end plate.

3. An optical-path turning member comprising:
a pair of end plates having two-dimensional arrays of optical fiber insertion holes and arranged at an, angle to each other, and
a hollow guide configured to curvilinearly guide optical fibers respectively inserted in optical fiber insertion holes of the pair of end plates.

4. An optical-path turning optical connector comprising an optical-path turning member according to claim 1 having a positioning groove outlet portion at an end of the curvilinear distal end face as a connector connection end face.

5. An optical-path tuning optical connector comprising an optical-path turning member according to claim 2 or 3 having a surface at an optical fiber insertion hole outlet side of at least one end plate as a connector connection end face.

6. An optical-path tuning member according to any of claims 1 to 3 comprising as an optical fiber thereof an optical fiber having less hooding loss than a standard optical fiber.
